(19) United States
(12) Patent Application Publication
(10) Pub. No.: US 2006/0045564 A1
(43) Pub. Date: Mar. 2, 2006

(54) Color image forming apparatus

(75) Inventors: Byung-Sun Ahn, Suwon-si (KR); Won-Taek Kim, Suwon-si (KR); Soo-Yong Jung, Suwon-si (KR); Dong-Ha Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/211,494

(22) Filed: Aug. 26, 2005

(30) Foreign Application Priority Data
Sep. 2, 2004 (KR) 2004-69975

(51) Int. Cl. G03G 15/00

(52) U.S. Cl. 399/110

(57) ABSTRACT

A color image forming apparatus is provided capable of easily assembling and controlling the elements relating to color registration and image quality. The apparatus includes an image forming module having a plurality of image forming units, exposure units, a transfer unit and an integrally formed image forming frame, and a main body in which the image forming module is detachably mounted by use of positioning members. Upon assembling the plurality of image forming units, exposure units and the transfer unit in the image forming frame, distances between the former elements are always maintained constant.

### CROSS-REFERENCE TO RELATED APPLICATIONS

This application claims benefit under 35 U.S.C. §119 from Korean Patent Application No. 2004-69975, filed on Sep. 2, 2004, the entire disclosure of which is hereby incorporated by reference.

### BACKGROUND OF THE INVENTION

1. Field of the Invention

The invention relates to a color image forming apparatus. More particularly, the present invention relates to a color image forming apparatus wherein spaced distances of image formation-related elements are maintained constant and easily regulated by assembling and mounting the elements.

2. Description of the Related Art

Referring to FIGS. 1 and 2, a conventional color image forming apparatus 1 comprises a plurality of image forming units 10 to form a color image, an exposure unit 20 which forms electrostatic latent images on surfaces of photosensitive members 11 constituting the image forming units 10, a first transfer unit 30 on which each of the images formed on the surfaces of the plurality of photosensitive members 11 is transferred and superimposed, a second transfer roller 40 for transferring the color image transferred on the transfer unit 30 to a printing medium (P) such as a sheet of paper, and a medium delivery unit 50 to deliver the printing medium (P) on which the color image is transferred and fixed to an exterior of a main body of the apparatus. The above elements are mounted to a main frame (not shown). In addition, the main frame is provided with a power supply section (not shown) for supplying power to each of the elements and a controlling section (not shown) which controls the elements and thus performs a printing operation.

The image forming units 10 are constructed so that, for example, yellow, magenta, cyan and black image forming units are vertically arranged in a row on one side of a transfer belt 31 of the first transfer unit 30. Each of the image forming units 10 comprises the photosensitive member 11, an electrification unit, a developing unit and a developing frame to store toner and support the elements. The first transfer unit 30 comprises the transfer belt 31 for supporting toner transferred from the photosensitive members 11 and a plurality of first transfer rollers 32 opposed to each of the photosensitive members 11 which generate a high voltage for transfer to the inside of the transfer belt 31.

When a printing command and printing data are received from a computer (not shown) connected to the color image forming apparatus 1, the controlling section turns on/off the exposure unit 20 according to the printing data, forms electrostatic latent images on surfaces of each of the photosensitive members 11, develops the electrostatic latent images with fine powdered toner, and then transfers/superimposes the developed images onto the transfer belt 31 with a high voltage of the first transfer rollers 32. Thus, a color image is formed. Then, the controlling section delivers the printing medium (P) with the medium delivery unit 50, transfers the color image, which is formed on the transfer belt 31, on the printing medium (P) by a high voltage of the second transfer roller 40, fixes the transferred image on the printing medium (P) with high temperature and pressure of a fixing member 51, and then discharges the printing medium (P) to an exterior of a main body 60, thereby completing one cycle.

At this time, in order to obtain a relatively good color image, it is required that the images formed on the photosensitive members 11 of the image forming units 10 should be correctly transferred/superimposed to the transfer belt 31, and the color images formed on the transfer belt 31 should be correctly transferred to the printing medium (P). This is accomplished by regularly maintaining straightness, parallelism, and spacing or pressure between the transfer belt 31 and the photosensitive members 11, and spacing or a pressure is also maintained between the transfer belt 31 and the second transfer roller 40. For accomplishing the aforementioned, accuracy of mounting positions of the transfer belt 31, and the plurality of first transfer rollers 32 and the image forming units 10, which are mounted to the main frame (not shown), is also preferred. In addition, it is required that an accuracy of a mounting position between the transfer belt 31 and the second transfer roller 40 of the main frame is also necessary.

For the purpose of satisfying the above requirements, according to the conventional color image forming apparatus, each of the image forming units 10 is constructed for mounting by reference holes 12 while being guided along a guide (not shown) formed on the main frame through openings (not shown) of positions defined according to colors, and the exposure unit 20 defines an assembly position basis on the same main frame or another sub frame fixed to the main frame. Consequently, focusing distance to the photosensitive member 11 of the image forming unit 10 and straightness in the directions of scanning and sub-scanning are regulated to meet designed values and then fixed. In addition, the transfer belt 31 of the first transfer unit 30 is regulated to maintain parallelism and straightness with the photosensitive members 11 and then fixed to the main frame. The first transfer rollers 32 are fixed to the mainframe so that the corresponding photosensitive members 11 and the transfer belt 31 can maintain a predetermined spacing or pressure. In particular, after regulating a distance between the second transfer roller 40 and the transfer belt 31, so that an image is correctly transferred to the printing medium (P), the second transfer roller 40 is fixed to the main frame. Meanwhile, a paper supply cassette of the medium delivery unit delivering the printing medium (P), which stores the printing medium (P), is mounted to a space formed in a lower part of the main frame by a guide unit, and all or a part of the medium delivery unit 50, which picks up and delivers the printing medium (P) in the paper supply cassette is fixed to the main frame. The fixing member 55 is also structured for assembly to the mainframe. In addition, although not shown, a drive means for driving each of the elements, a power supply section for supplying and controlling power to the elements, and a controlling section are also fixed to the main frame. Additionally, the main frame functions to support the entire image forming apparatus while fixing various kinds of additional parts and exterior parts. Since the main frame has such a structure, it should have a high accuracy as a whole, a high strength and durability so that it is not varied during an extended service lifecycle.

According to the conventional image forming apparatus having the above-mentioned structure, firstly, since various kinds of elements are assembled or mounted to the main frame, it is very difficult to perform controls for matching focal distances, parallelism of scanning direction and straightness of the sub-scanning direction between the image forming units and the exposure unit. Therefore, color registration of the color image is very difficult. Secondly, since uniform pressure or maintenance of the distance between each of the photosensitive members and the transfer belt should be determined in the main frame, there are many reference positions in the main frame, so, dimension management is difficult. In addition, when a dimension is irregular, color realization is difficult because deviation of transfer efficiency occurs. Thirdly, when a dimension deviation occurs in every developing unit, it is difficult to maintain accuracy of the registration because it is difficult to maintain accuracy of dimension in every developing unit in the main frame supporting the entirety of the apparatus. Fourthly, deviation of an exposure position, due to a position deviation between the developing units also occurs, so, color bending results. Fifthly, since errors occur in the accuracy of dimension and straightness, which are maintained to be constant in the first assembling, due to heat distortion and a wear, results in poor color registration. Therefore, it is very difficult to match the color registration through a regulation of the first transfer unit and the image forming units which are mounted to the main frame.

Accordingly, there is a need for an image forming unit with improved agreement of color registration between a transfer unit and a photosensitive member to constantly maintain straightness and parallelism between an exposure unit and the photosensitive member.

### SUMMARY OF THE INVENTION

An aspect of the present invention is to solve at least the above problems and/or disadvantages and to provide at least the advantages described below. Accordingly, an aspect of the present invention is to prevent a disagreement of color registration between a transfer unit and a photosensitive member due to dimensional non-uniformity of a main frame to constantly maintain straightness and parallelism between an exposure unit and the photosensitive member of an image forming unit, by assembling and mounting the plurality of image forming units, the exposure unit and the transfer unit to an image forming frame formed in an integral body.

Another object of the invention is to assemble and mount/dismount an image forming unit, an exposure unit and a transfer unit, which are related to a color image formation, to a separate image forming frame formed in an integral body. Thus, the dimensional management required for controlling the accuracy of color registration or exposure of a color image is limited to a dimension of the image forming frame. This facilitates the dimensional management and thus the processing of related parts, and also facilitates the control of the image forming unit, the exposure unit and the transfer unit when one of them is replaced.

In addition, another object of the invention is to improve an assembling performance by sub-assembling an image forming unit, an exposure unit and a transfer unit to an image forming frame and then assembling the image forming frame to a main frame, and to easily regulate image quality during assembly, by regulating only a distance between a medium delivery unit mounted to a main body and the image forming frame. Thus, making it possible to control an image quality for transfer onto a sheet.

Additionally, another object of the invention is to minimize heat distortion, deformation due to wear, and an effect due to an impact from other units, thereby maintaining uniformity and reliability of image quality.

Another object of the invention is to make it possible to mount or dismount an image forming frame module assembled with an image forming unit, to or from a side of a main frame, thereby improving convenience of handling of a color image forming apparatus.

The above object of the present invention is substantially realized by providing a color image forming apparatus comprising an image forming module including a plurality of elements comprising a plurality of image forming units having photosensitive members, a plurality of exposure units to expose the photosensitive members, a transfer unit to which an image formed on the photosensitive member is transferred, and an image forming frame to detachably receive and support the plurality of elements. A main body, to which the image forming module is removably mounted, includes a second transfer roller for transferring the image formed on the transfer unit to a printing medium. A medium delivery unit delivers the printing medium between the transfer unit and the second transfer roller.

Preferably, the image forming frame may be integrally formed.

In addition, the image forming frame may preferably comprise mounting recesses to which the image forming units and the exposure units are respectively mounted and the apparatus may further include positioning members which determine a correct position when the units are mounted to the corresponding mounting recesses

Preferably, the positioning members may comprise a reference pin and a reference hole corresponding thereto, each formed to any one of the image forming frame and the image forming unit and to any one of the image forming frame and the exposure unit. In addition, preferably, the positioning members of the exposure unit may comprise an exposure unit-supporting section and a corresponding surface provided to the image forming frame and the exposure unit, respectively.

In addition, the color image forming apparatus of the invention may preferably comprise a frame-positioning assembly, which determines a correct position of the image forming module in the main body, when the image forming module is mounted to the main body. At this time, the frame-positioning assembly may preferably comprise a plurality of reference protrusions formed on the frame of the image forming module and reference grooves formed on the main body corresponding to the reference protrusions.

Additionally, the image forming frame may preferably be provided with a connector allowing the image forming module to be automatically and electrically connected or disconnected to or from a power supply section and a controlling section of the main body when the image forming module is mounted or dismounted.

Further, preferably, the transfer unit may comprise a transfer belt and a plurality of transfer rollers which are mounted inside of the transfer belt to correspond to the photosensitive members.

In accordance with another embodiment of the invention, there is provided a color image forming apparatus comprising an image forming module having a plurality of elements comprising a photosensitive member, a plurality of electrification units to forming an image on the photosensitive member, exposure units and developing units, and an image forming frame for detachably receiving and supporting the plurality of elements, and a main body to which the image forming module is removably mounted and including a medium delivery unit delivering a printing medium so that the image is transferred from the photosensitive member. At this time, preferably, the image forming frame may be integrally formed.

Preferably, the image forming frame may comprise mounting recesses to which the photosensitive member, and the plurality of electrification units, developing units and exposure units are respectively mounted, and positioning members for determining a correct position when the units are mounted to the corresponding mounting recesses.

In accordance with another embodiment of the invention, there is provided a color image forming apparatus comprising an image forming module having a plurality of elements comprising a plurality of image forming units having photosensitive members, a plurality of exposure units to expose the photosensitive members, a transfer unit to transfer an image formed on the photosensitive member to a printing medium and an image forming frame to detachably receive and support the plurality of elements, and a main body to which the image forming module is removably mounted and including a medium delivery unit to deliver the printing medium to the transfer unit. At this time, preferably, the image forming frame may be integrally formed.

Preferably, the transfer unit may comprise a delivery belt and a plurality of transfer rollers which are mounted inside of the delivery belt to correspond to the photosensitive members.

As described above, according to the color image forming apparatus of the invention, main parts relating to the image formation, such as the image forming unit, the exposure unit, and the transfer unit, are respectively mounted to a main frame, are provided as an image forming module assembled to a separate image forming frame, and then assembled to a main frame, so that it is possible to prevent a disagreement of color registration between the exposure unit and the photosensitive member due to a dimensional error of parts.

In addition, since the positions of the image forming units, the exposure units and the transfer unit are determined by each of the positioning means provided to the integral image forming frame to meet predetermined dimensions, distances between the elements are maintained constant, and the color registration is correctly maintained and an assembly performance is improved.

Further, main parts relating to the image formation are structured as the image forming module formed in an integral body. Thus, it is possible to reduce heat distortion, deformation due to wear, and an effect due to an impact from other units, even when they are used for a relatively long time period. Accordingly, it is possible to uniformly maintain image quality for a long time, thereby improving reliability.

In addition, the image forming module is structured to be mounted and detached to and from a side of the main body. Thus, productivity is improved and it is possible to easily perform an A/S operation after sale. In particular, when the image forming unit or exposure unit is replaced or repaired, since a regulation for agreement of the color registration is performed in the image forming module only, the regulation is very convenient in A/S.

In particularly, according to conventional units, the main frame supports most of the elements of the color image forming apparatus. Thus, it is made of a material having high strength, many reinforcing members are used, and a management of many dimensions is preferable. Accordingly, processing is difficult and the number of the parts, material costs and a weight of a product are increased. However, according to the exemplary embodiments of the present invention, since a processing dimension related to an image quality is managed only for the small image forming frame compared to the main body, the material having high strength is minimized and a use of the reinforcing member is minimized. Consequently, it is possible to reduce the number of the parts, the material costs and the weight.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a conceptual view of a conventional color image forming apparatus;

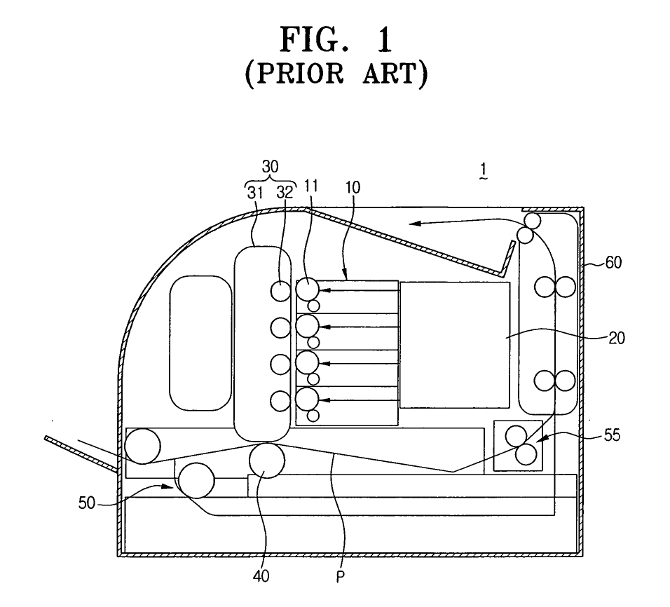

FIG. 2 is a perspective view showing elements relating to an image formation in the color image forming apparatus shown in FIG. 1;

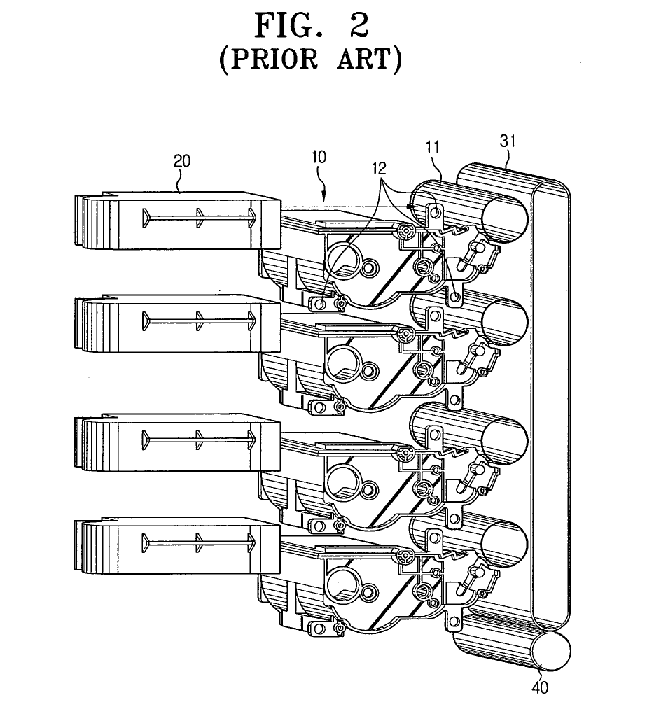

FIG. 3 is a conceptual view showing a color image forming apparatus according to a first exemplary embodiment of the invention;

FIG. 4 is a perspective view showing an image forming module of FIG. 3;

FIG. 5 is a perspective view showing the image forming module of FIG. 3, from an opposite view of that of FIG. 4;

FIG. 6 is a partial perspective view showing positioning members of an image forming unit of FIG. 5 in detail;

FIG. 7 is a perspective view showing a back of the image forming module shown in FIG. 3;

FIG. 8 is a side sectional view of the image forming module of FIG. 3;

FIG. 9 is a conceptual view showing a color image forming apparatus according to a second exemplary embodiment of the invention;

FIG. 10 is a perspective view of an image forming module of FIG. 9; and

FIG. 11 is a conceptual view showing a color image forming apparatus according to a third exemplary embodiment of the invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

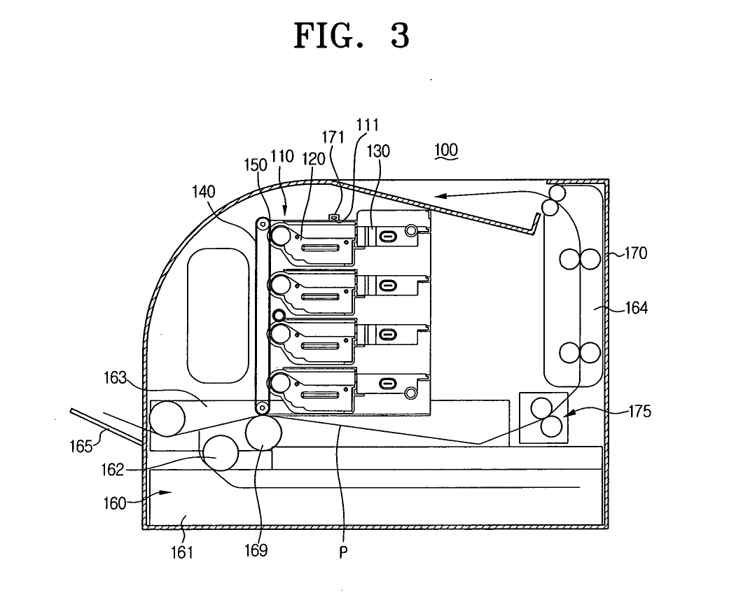

Referring to FIG. 3, a color image forming apparatus 100 according to an exemplary embodiment of the invention comprises an image forming module 110, a medium delivery unit 160, and a main body 170 in which the image forming module 110, the medium delivery module 160 and a second transfer roller 169 are received.

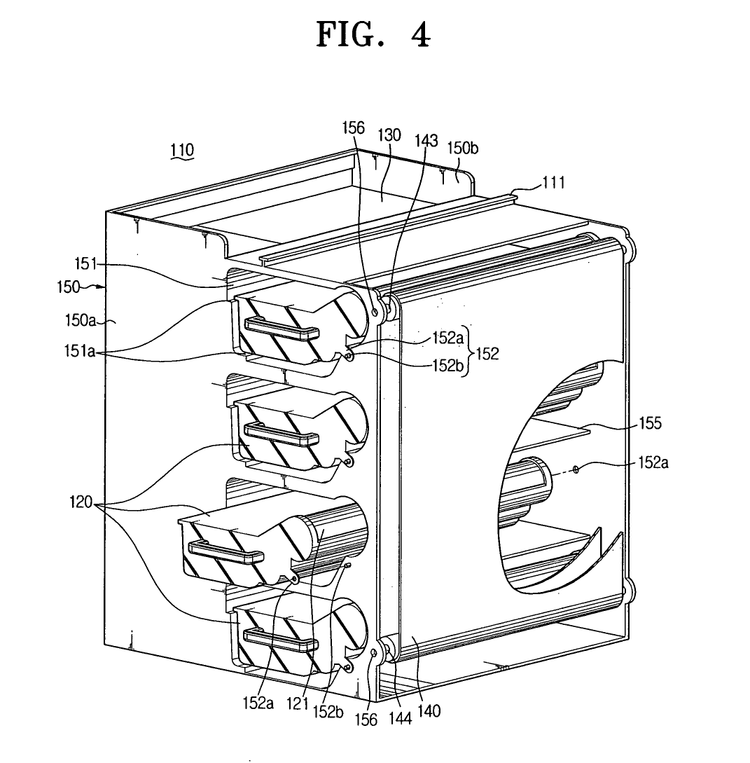

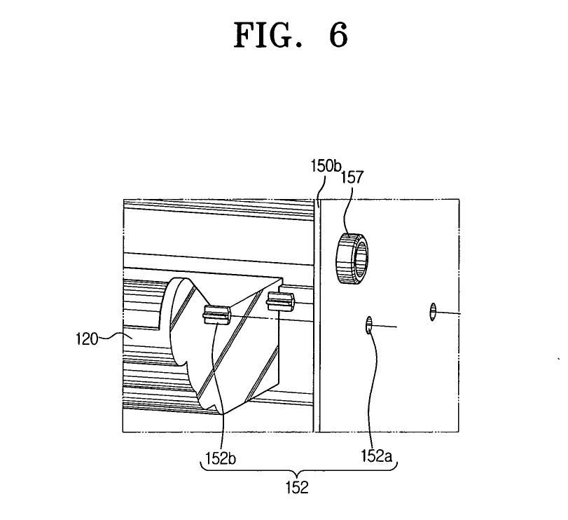

The image forming module 110 comprises a plurality of image forming units 120, a plurality of exposure units 130, a transfer unit 140 and an image forming frame 150. An example thereof is shown in FIGS. 4 to 8. The image forming frame 150 is provided with mounting recesses 151 to which the image forming units 120 and the exposure units 130 can be mounted. In other words, a sidewall 150a of the image forming frame 150 is provided with a plurality of mounting recesses 151 to insertably mount and dismount the image forming units 120. The other side thereof is provided with separate mounting recesses to mount and dismount the exposure units 130. The mounting recess 151 is provided with a guide 151a for guiding the mounting and dismounting of the image forming unit 120, and the image forming unit 120 and the image forming frame 150 are provided with positioning members 152 for correctly fixing the image forming unit 120 to a predetermined position regarding the image forming frame 150 even when the image forming unit 120 is mounted and dismounted. The positioning members 152 are structured so that distances between photosensitive members 121 of the image forming units 120 mounted to the mounting recesses 151 are equal and straightness and parallelism therebetween are maintained constant. The positioning members 152 comprise a first reference hole 152a formed in a sidewall 150b opposed to the sidewall 150a in which the mounting recess 151 is formed, and a first reference pin 152b formed in a corresponding sidewall of the image forming unit 120 (refer to FIG. 6). As shown in FIG. 4, the sidewall 150a of the image forming unit 150, in which the mounting recess 151 is formed, is also provided with the first reference pin 152b, and the corresponding side of the image forming unit 120 is formed with the reference hole 152a into which the first reference pin 152b is inserted. Accordingly, the image forming units 120 are respectively fixed to prescribed positions regarding the image forming frame 150 simply by inserting the image forming units 120 in the mounting recesses 151. At this time, the first reference pin 152b and the first reference hole 152a may be selectively formed in any one of the image forming units 120 and the image forming frame 150 corresponding to each other as needed, in addition to the above-mentioned positions. For the positioning members 152, various other suitable arrangements and constructions may be used in addition to the reference pin/reference hole arrangement. Further, a partition wall 155 is preferably provided between the adjacent mounting recesses 151 of the image forming frame 150. Thus, it is possible to minimize a mutual interference of the adjacent image forming units 120. As the image forming units 120, four units for a yellow, magenta, cyan and black are typically used to form a color image. The image forming unit 120 comprises a photosensitive drum as the photosensitive member 121, an electrification unit for electrifying the photosensitive drum 121 and a developing unit for developing an electrostatic latent image formed on the photosensitive drum 21 by a laser beam emitted from the exposure unit 130. The developing unit comprises a developing roller supplying toner to the photosensitive member 121, a supply roller, and a developing frame storing the toner and supporting the photosensitive drum 121, the electrification unit, the developing unit and the supply roller. In addition, the image forming unit 120 comprises a regulation member constantly regulating a height of the toner delivered to the developing roller.

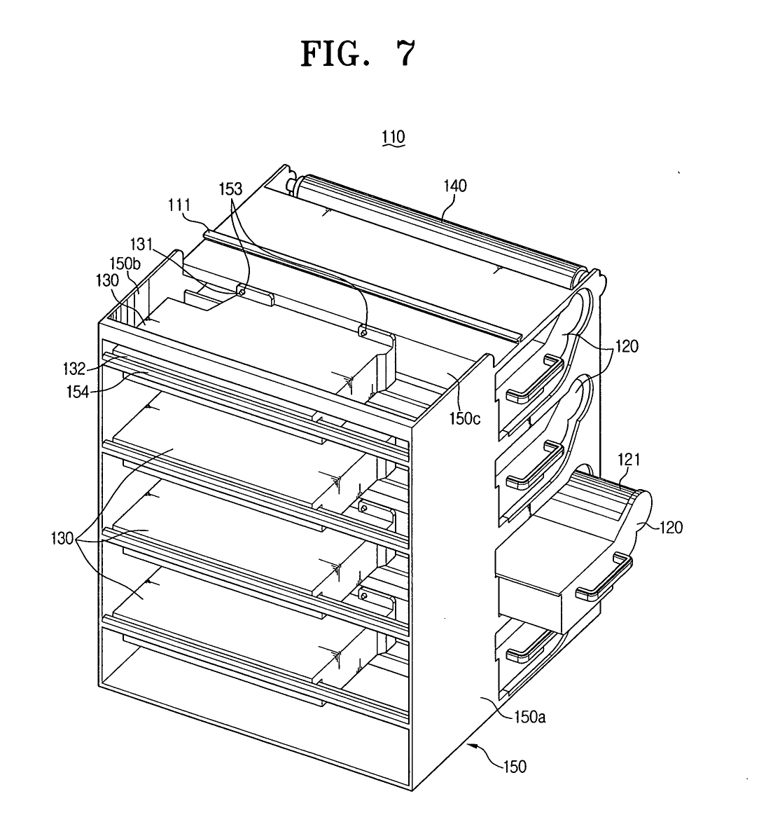

Referring to FIG. 7, the exposure unit 170, such as, a laser scanning unit is mounted to a side of the image forming unit 120 to scan the laser beam to the photosensitive member 121 of the image forming unit 120. A position thereof is determined by two second reference pins 153 provided proximal to a middle wall 150c connecting both of the sidewalls 150a, 150b of the image forming frame 150 and an exposure unit-supporting section 154 provided to a rear end of the image forming frame 150. Thus, a scanning line of the laser beam emitted from the exposure unit 130 is parallel to a rotational axis of the photosensitive member 121. At this time, second reference holes 131 corresponding to the second reference pins 153 are provided to a front surface of the exposure unit 130 and a corresponding surface 132 corresponding to the exposure unit-supporting section 154 is provided to a back surface thereof. Accordingly, it can be structured so that the laser beam emitted from the exposure unit 130 can be scanned parallel with the corresponding rotational axis of the photosensitive member 121 of the image forming unit 120. This is done by simply inserting the second reference pin 153 into the second reference hole 131 of the exposure unit 130 with. Then, the exposure unit is placed on the exposure unit-supporting section 153. The positioning members 131 and 153, 132 and 154 of the exposure unit 130, shown in FIG. 7, can be used to fix the exposure unit 130 to a predetermined position of the image forming unit 154.

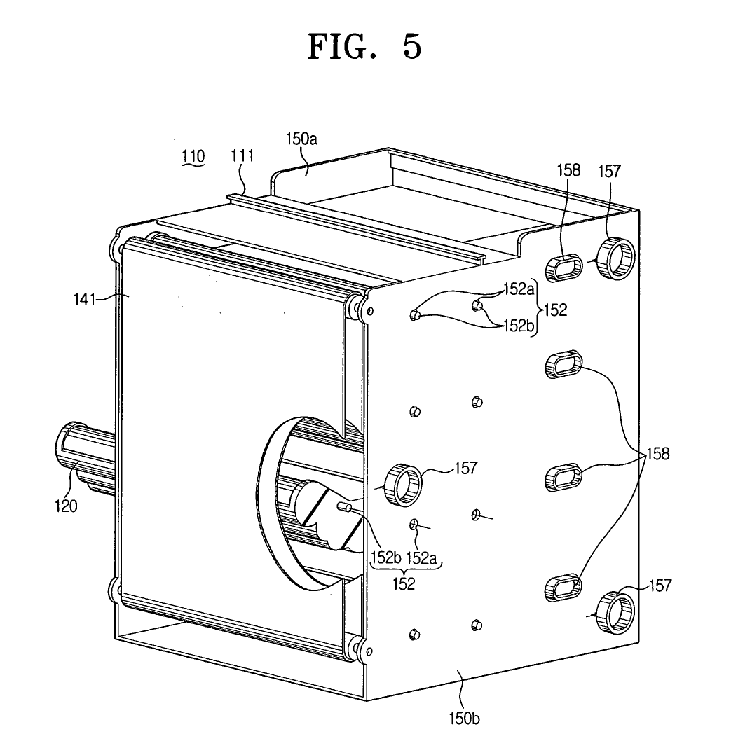

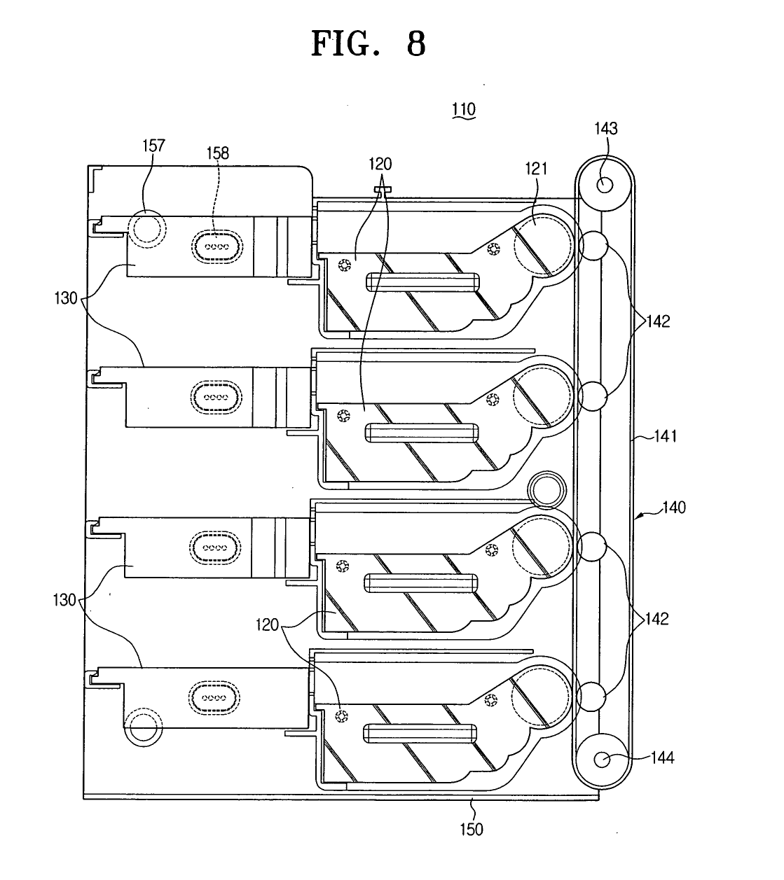

As shown in FIG. 8, the transfer unit 140 comprises a transfer belt 141 that is assembled to a front surface of the image forming frame 150 and to which the images formed on the photosensitive members 121 are transferred/superimposed. A plurality of first transfer rollers 142 are located inside of the transfer belt 141 and allow the image formed on the corresponding photosensitive member 121 to be transferred to the transfer belt 141. The image forming frame 150 is formed with third reference holes 156 (FIG. 4), to which a driving roller axis 143 and a driven roller axis 144 of the transfer belt 141 are respectively assembled, so that the photosensitive members 121 of the image forming units 120 and the transfer belt 141 are assembled at a predetermined distance. Accordingly, the transfer belt 141 is assembled for location at the predetermined distance from the photosensitive member 121 of the image forming unit 120 just by assembling the driving roller axis 143 and the driven roller axis 144 of the transfer belt 141 to the third reference holes 156 formed in the image forming frame 150. In FIGS. 4 and 5, the first transfer roller 142 is omitted for clarity and conciseness. The first transfer roller 142 is preferably structured so that it can regulate a distance between the photosensitive member 121 of the image forming unit 120 and the transfer belt 141 according to kinds of the colors, as needed. In addition, the mounting position of the first transfer roller 142 is preferably located at a predetermined distance on the basis of the third reference hole 156 of the image forming frame 150.

As described above, the image forming frame 150 comprises the positioning members at positions to which the elements 120, 130, 140 are assembled and mounted so that the image forming units 120, the exposure units 130, and the transfer unit 140 can be mounted at a predetermined distance from each other.

In addition, it is formed in an integral body so as not to be deformed even when it is processed and used for a long time, and made of a material having good durability.

Further, preferably, the image forming frame 150 is structured to be mounted and dismounted to and from one side of the main body 170, and comprises frame-positioning assembly so that a position thereof is automatically determined when it is mounted to the main body 170. The image forming frame 150 and the main body 170 are provided with a guide rail 111 and a frame guide 171, respectively, so that the image forming frame 150 can be mounted and dismounted by sliding or reciprocal linear movement relative to the main body 170. In addition, the frame-positioning assembly comprises a reference groove (not shown) provided for a wall of the main body 170 to which the image forming frame 150 is mounted and a reference protrusion 157 provided to a corresponding surface of the image forming frame 150, as shown in FIG. 5, and allows a position of the image forming module 110 to be correctly determined automatically when the image forming frame 150 is mounted to the main body 170. At this time, the reference groove and the reference protrusion 157 are formed so that the transfer belt 141 mounted to the image forming frame 150 maintains a predetermined distance with the second transfer roller 169 mounted to the main body 170. Accordingly, when the image forming frame 150 is mounted to the main body 170 along the guide rail 111 and the frame guide 171, the reference protrusion 157 of the image forming frame 150 is inserted into the reference groove of the main body 170. Thus, the transfer belt 141 of the image forming frame 150 is fixed while maintaining the predetermined distance with the second transfer roller 169 of the main body 170. Then, the image is transferred from the transfer belt 141 which is assembled with the image forming frame 150, to a printing medium (P) delivered between the transfer belt 141 and the second transfer roller 169. Even if a distance between the transfer belt 141 and the second transfer roller 169 deviates from a standard due to an error of an part or other causes and thus a poor image results, it is possible to correct the distance therebetween by regulating a position of the image forming frame 150 or the second transfer roller 169. Consequently, an image quality can be relatively easily controlled.

In addition, the sidewall of the image forming frame 150, to which the reference protrusion 157 is formed, is provided with a connector 158 for allowing the elements 120, 130, 140 to make an electrical connection with a power supply section and a controlling section of the main body 170. A counter connector (not shown), which is connected to the power supply section and the controlling section and coupled to the connector 158, is provided to a corresponding surface of the main body 170. At this time, the connector 158 and the counter connector is structured for electrical connection and disconnection automatically when the image forming module 110 is mounted and dismounted to and from the main body 170. Accordingly, when the image forming module 110 is mounted along the frame guide 171 provided to the main body 170, the electrical connection between the image forming module 110 and the power supply section and the controlling section of the main body 170 is automatically made. Thus, a color image is formed in the image forming module 110 and transferred to the printing medium (P) according to a signal of the controlling section.

The medium delivery unit 160 allows the image formed in the image forming module 110 to be transferred to the printing medium (P) such as a printing sheet, and discharges the printing medium (P) having the image transferred thereto to an exterior of the main body 170. The medium delivery unit 160 comprises a paper supply cassette 161 in which the printing medium (P) is loaded, a pick-up roller 162 for picking up the loaded printing medium (P) one by one, a delivery unit 163 for moving the picked-up printing medium (P) between the transfer belt 141 and the second transfer roller 169 and allowing the image to be transferred to the printing medium (P), and a paper discharge unit 164 for discharging the printing medium (P) having the image transferred thereto into the exterior of the main body 170. The medium delivery unit 160 may be further provided with an MP unit 165 manually supplying various kinds of printing medium (P).

The main body 170 comprises a frame (not shown), to which the image forming module 110 and the medium delivery unit 160 are fixed, a cover (not shown) covering the frame, a power supply section (not shown) for supplying a required power and a controlling section (not shown) for controlling the image forming module 110 and the medium delivery unit 160. In addition, a fixing member 175 for fixing the image, which is transferred to the printing medium (P), to the printing medium (P) is further mounted between the delivery unit 163 and the paper discharge unit 164.

Hereinafter, an assembly process of the color image forming apparatus having the above-described structure according to a first embodiment of the invention will be explained regarding the invention.

Firstly, the image forming module 110 is completed by assembling the plurality of image forming units 120, the exposure units 130 and the first transfer unit 140 to the image forming frame 150. At this time, the image forming units 120 are inserted into the mounting recesses 151 formed in the image forming frame 150, so that the positioning members 152 are matched and the exposure units 130 are matched with the second reference pins 153 and the exposure unit-supporting section 154, thereby making the distances, the parallelism and the straightness of the elements 120, 130, 140 be within the prescribed dimensional ranges.

Next, the main body 170 is completed by assembling the medium delivery unit 160, the fixing member 175, the power supply section and the controlling section to the main frame.

Finally, the assembly of the color image forming apparatus 100 is completed by mounting the guide rail 111 of the image forming module 110 to one side of the main body 170 along the frame guide 171. At this time, the distance between the transfer belt 141 of the image forming module 110 and the second transfer roller 169 is made to be within the prescribed range just by mounting the image forming module 110 along the frame guide 171 and thus fitting the reference protrusion 157 of the image forming module 110 into the reference groove of the main body 170.

When a printing command is received from a computer (not shown) connected to the controlling section, the controlling section operates the electrification unit of the image forming unit 120 to electrify the surface of the photosensitive drum 121, and controls the exposure unit 130 to scan the laser beam according to the printing data, thereby forming an electrostatic latent image on the photosensitive drum 121. The electrostatic latent image of the photosensitive drum 121 is developed into a specific color of an image by the developing unit of the image forming unit 120. The images formed on each of the photosensitive drums 121 of the plurality of image forming units 120 are transferred and superimposed to the transfer belt 141, thereby forming a color image. The color image formed on the transfer belt 141 is transferred to the printing medium (P) which is picked-up from the paper supply cassette 161 and then delivered between the second transfer roller 169 and the transfer belt 141 according to the signal of the controlling section. The printing medium (P) having the image transferred thereto is fixed with the image while passing through the fixing member 175 by the delivery unit 163, and then discharged into the exterior of the main body 170 via the paper discharge unit 164. The operations like this are repeated according to the printing command of the computer.

As described above, the image forming frame 150 comprising the image forming module 110 is structured to be mounted and detached to and from the side of the image forming frame 150. However, the image forming unit 120 may be structured to be mounted and dismounted to and from a front or rear surface of the image forming frame 150. In this case, likewise the above example, the positioning members is also provided to the image forming unit and the image forming frame so that positions of the image forming units can be determined just by mounting the image forming units to the image forming frame. Accordingly, a detailed description thereof based on the drawings is omitted for clarity and conciseness.

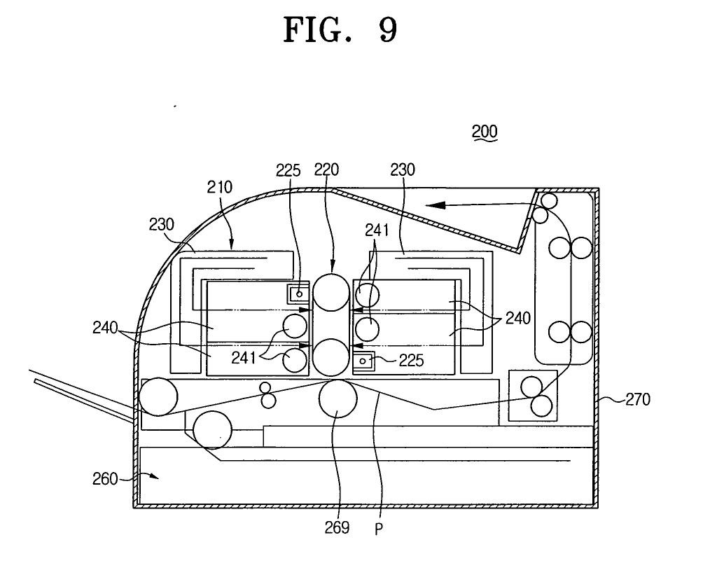

FIG. 9 is a conceptual view showing a color image forming apparatus according to a second embodiment of the invention. Referring to FIG. 9, a color image forming apparatus 200 according to a second embodiment of the invention comprises an image forming module 210, a medium delivery unit 260 and a main body 270 in which the image forming module 210 and the medium delivery unit 260, are received.

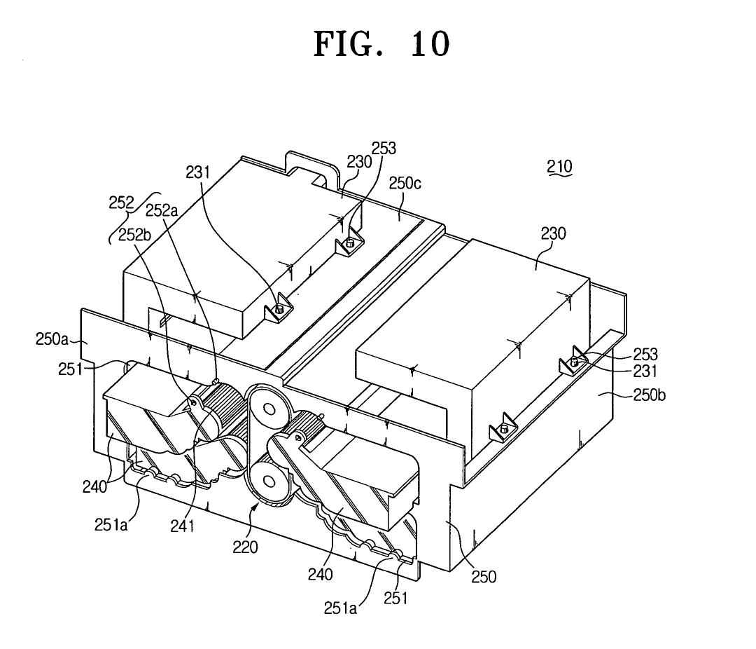

The image forming module 210 comprises a photosensitive member 220, a plurality of electrification units 225, a plurality of developing units 240, a plurality of exposure units 230 and an image forming frame 250 and an example thereof is shown in FIG. 10. The image forming frame 250 is provided with mounting recesses to which the plurality of developing units 240, the exposure units 230, the electrification units 225 and the photosensitive member 220 can be mounted, respectively. A front wall of the image forming frame 250 is formed with a plurality of mounting recesses 251 in two rows to insertably mount and dismount the developing units 240. At this time, the mounting recess 251 is provided with a guide 251a for guiding the mounting and dismounting of the developing units 240, and the developing unit 240 and the image forming frame 250 are provided with positioning members 252 so that the developing unit 240 is always fixed at a predetermined location regarding the image forming frame 250 when the developing unit 240 is mounted. The positioning members 252 is structured so that a distance between axes of developing rollers 241 of the developing units 240 respectively mounted to the mounting recesses 251 is equal and straightness and parallelism thereof are constantly maintained. The positioning members 252 comprises a first reference hole (not shown) formed in a sidewall opposed to a sidewall 250a of the image forming frame 250 in which the mounting recesses 251 are formed and a first reference pin (not shown) formed in a side of the corresponding developing unit 240. In addition, the sidewall 250a of the image forming frame 250, in which the mounting recesses 251 are formed, is also provided with the first reference pin 252a, and a side of the corresponding developing unit 240 is formed with the first reference hole 252b into which the first reference pin 252a is inserted. Accordingly, the plurality of developing units 240 are fixed at predetermined locations regarding the image forming frame 250 simply by inserting the developing units 240 into the mounting recesses 251. At this time, the first reference pin 252a and the first reference hole 252b may be selectively formed in any one of the developing unit 240 and the image forming frame 250 corresponding to each other, as needed, in addition to the above-mentioned locations. As for the positioning members 252, various suitable arrangements and constructions may be used in addition to the reference pin/reference hole ways. Additionally, a partition wall may be formed between the mounting recesses 251 vertically located of the image forming frame 250. Thereby, it is possible to minimize an interference occurring between the adjacent developing units 240. As the image forming units 240, four units for yellow, magenta, cyan and black are typically used to form a color image. The developing unit 240 develops the electrostatic latent image formed on a surface of the photosensitive member 220, and comprises a developing roller 241 supplying toner to the photosensitive member 220, a supply roller and a developing frame storing the toner and supporting the developing roller 241 and the supply roller. In addition, the developing unit 240 further comprises a regulation member constantly regulating a height of the toner delivered to the developing roller 241.

The photosensitive member 220 is assembled to the image forming frame 250 so that it is located between the mounting recesses 251 formed in two rows. The photosensitive member 220 uses a photosensitive belt to correspond to the developing units 240 which are located two by two at both sides. Two electrification units 225 are provided with the image forming frame 250 so that each of the electrification units 225 can electrify one and the other surfaces of the photosensitive belt 220, respectively. At this time, it is possible to maintain the distances between the photosensitive belt 220 and the plurality of developing units 240 constant by managing a dimension between an assembly position of a roller driving the photosensitive belt 220 and the positioning members 252 of the developing unit 240. In addition, a mounting position of the electrification unit 225 is determined on the basis of the photosensitive belt 220.

An exposure unit 230 such as a laser scanning unit is mounted one by one to a side of the image forming units 240 located in two rows to scan the laser beam to the photosensitive belt 220 as the photosensitive member, and the position thereof is determined by two second reference pins 253 provided to a upper ceiling 250c connecting front and rear walls of the image forming frame 250 and two reference pins 253 provided to the sidewall 250b of the image forming frame and two reference pins 253 provided to the sidewall 250b of the image forming frame 250 so that scanning lines of the laser beam emitted from the exposure unit 230 are parallel to each other on the photosensitive belt 220. At this time, second reference holes 231, corresponding to the second reference pins 253, are provided to a corresponding surface of the exposure unit 230. Accordingly, it can be structured such that the laser beam emitted from the exposure unit 230 can be scanned to be parallel with each other on the photosensitive belt 220 just by fitting the second reference hole 231 of the exposure unit 230 with the second reference pin 253. The positioning members 231 and 253 of the exposure unit 230 shown in FIG. 10 are provided as an example, any one of the suitable positioning members can be used to fix the exposure unit 230 to a predetermined position of the image forming unit 250.

The image forming frame 250 is formed in an integral body so that the elements can be assembled to a predetermined location, and formed with the mounting recesses 251 to which the developing units 240 can be mounted and dismounted. The photosensitive member 220 is assembled between the mounting recesses 251 in two rows. In addition, the image forming frame 250 is structured so that it can be mounted and detached by sliding or reciprocally linear-moving the image forming frame 250 relative to the main body 270, as with the first embodiment. Accordingly, it is assembled so that a distance between the photosensitive member 220 of the image forming module 210 and the transfer roller 269 assembled to the main body 270 is made to be within a prescribed dimensional range just by mounting the image forming module 210 having the photosensitive member 220, the plurality of developing units 240, the exposure units 230, and the electrification units 225, which are assembled to the image forming frame 250, to the main body 270.

Since the color image is applied directly to the printing medium (P) from the photosensitive member 220, the medium delivery unit 260 and the main body 270 are not provided with the transfer unit 140 (refer to FIG. 3). However, except for these, the elements thereof are nearly same as the first embodiment, so a detailed explanation thereof is omitted for clarity and conciseness.

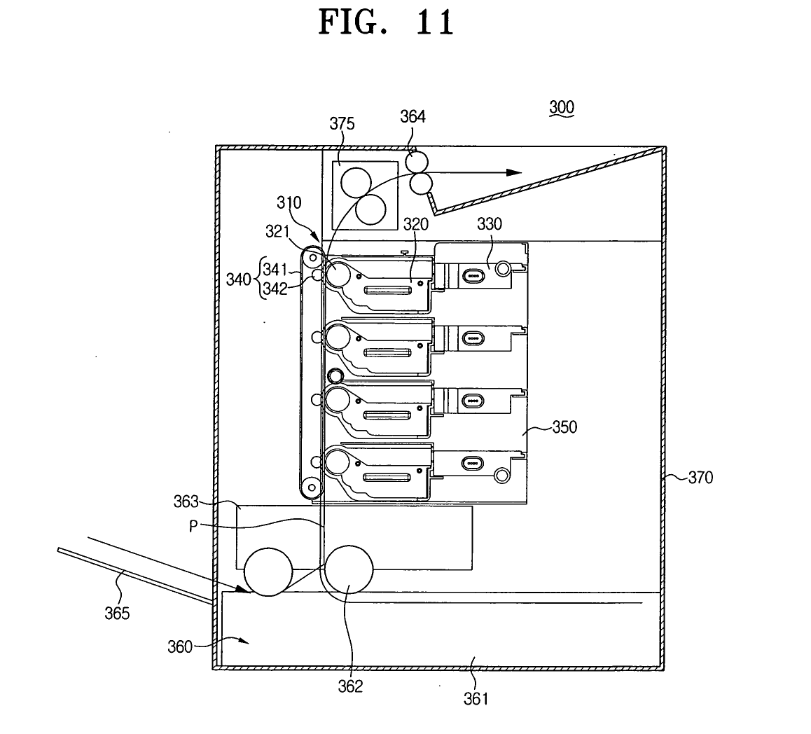

FIG. 11 is a conceptual view showing a color image forming apparatus according to a third exemplary embodiment of the invention. Referring to FIG. 11, a color image forming apparatus 300 according to a third embodiment of the invention comprises an image forming module 310, a medium delivery unit 360 and a main body 370 in which the image forming module 310 and the medium delivery unit 360 are received.

The image forming module 310 comprises a plurality of image forming units 320 vertically positioned in a row, a plurality of exposure units 330 positioned in a row at a side of the image forming unit 320, a transfer unit 340 comprising a delivery belt 341 and transfer rollers 342, and an image forming frame 350. The delivery belt 341 of the transfer unit 340 is mounted to a front of photosensitive drums 321 of the image forming units 320 positioned in a row, similarly to the transfer belt 141 of the color image forming apparatus 100 according to the first exemplary embodiment of the invention, and the transfer rollers 342 are mounted inside the delivery belt 341 to correspond to the photosensitive drums 321. In order to constantly maintain a positional relationship between the elements, even when the image forming units 320, the exposure units 330 and the transfer unit 340 are assembled, mounted or detached, positioning members are provided in accordance with the image forming module 110 of the color image forming apparatus 100 according to the first exemplary embodiment of the invention. Accordingly, a detailed description thereof is omitted for clarity and conciseness.

The medium delivery unit 360 delivers the printing medium (P) to the image forming module 310 and discharges the printing medium (P) having the image transferred in the image forming module 310 into the exterior of the main body 370. The medium delivery unit 360 comprises a paper supply cassette 361 in which the printing medium (P) is loaded, a pick-up roller 362 picking up the loaded printing medium (P) one by one, a pick-up unit 363 moving the picked-up printing medium (P) between the transfer belt 341 and the photosensitive drum 321 of the image forming unit 320 and a paper discharge unit 364 discharging the printing medium (P) having the image transferred thereto into the exterior of the main body 370. The medium delivery unit 360 may be further provided with a MP unit 365 for manually supplying various kinds of printing medium (P).

The main body 370 comprises a frame (not shown) to which the image forming module 310 and the medium delivery unit 360 are fixed, a cover (not shown) covering the frame, a power supply section (not shown) supplying a required power and a controlling section (not shown) controlling the image forming module 310 and the medium delivery unit 360 to perform a printing operation. In addition, a fixing member 375 is further provided between the image forming module 310 and the paper discharge unit 364 to fix the image transferred to the printing medium (P).

Hereinafter, an operation of the color image forming apparatus according to the third exemplary embodiment of the invention will be specifically described.

When a printing command and printing data are received from a computer (not shown) connected to the controlling section, the controlling section operates the electrification unit of the image forming unit 320 to electrify the surface of the photosensitive drum 321, and controls the exposure unit 330 to scan the laser beam according to the printing data, thereby forming an electrostatic latent image on the photosensitive drum 321. The electrostatic latent images formed on the photosensitive drums 321 are respectively developed into specific colors of images by the developing units of the image forming units 320. The images developed on each of the photosensitive drums 321 of the plurality of image forming units 320 are transferred/superimposed to the printing medium (P), which is delivered between the delivery belt 341 and the photosensitive drums 321, by the transfer rollers 342, thereby forming a color image. The printing medium (P) having the image transferred thereto is fixed with the image while passing through the fixing member 375 and then discharged into the exterior of the main body 170 via the paper discharge unit 364. The operations like this are repeated according to the printing command of the computer.

While the invention has been shown and described with reference to certain embodiments thereof, it will be understood by those skilled in the art that various changes in form and details may be made therein without departing from the spirit and scope of the invention as defined by the appended claims.

What is claimed is:

1. A color image forming apparatus comprising:
an image forming module including a plurality of image forming units having a plurality of elements comprising photosensitive members, a plurality of exposure units to expose the photosensitive members, a transfer unit to which an image formed on the photosensitive member is transferred, and an image forming frame which detachably receives and supports the plurality of elements; and
a main body to which the image forming module is removably mounted and including a second transfer roller for transferring the image formed on the transfer unit to a printing medium, and a medium delivery unit for delivering the printing medium between the transfer unit and the second transfer roller.

2. The apparatus as claimed in claim 1, wherein the image forming frame is integrally formed.

3. The apparatus as claimed in claim 1, further comprising:
a plurality of mounting recesses formed in the image forming frame to receive the image forming units and the exposure units, respectively; and
a plurality of positioning members which determine a correct position when the image forming units and the exposure units are mounted to the corresponding mounting recesses.

4. The apparatus as claimed in claim 3, wherein the positioning members which determine a correct position comprise a reference pin and a reference hole corresponding thereto, each formed to any one of the image forming frame and the corresponding image forming unit and to any one of the image forming frame and the corresponding exposure unit.

5. The apparatus as claimed in claim 4, wherein the positioning members of the exposure unit further comprise an exposure unit-supporting section and a corresponding surface, provided to the image forming frame and the corresponding exposure unit, respectively.

6. The apparatus as claimed in claim 1, further comprising a frame-positioning assembly for determining a position of the image forming module in the main body when the image forming module is mounted to the main body.

7. The apparatus as claimed in claim 6, wherein the frame-positioning assembly comprises a plurality of reference protrusions formed on the frame of the image forming module and a plurality of reference grooves formed on the main body and corresponding to the reference protrusions.

8. The apparatus as claimed in claim 1, wherein the image forming frame is provided with connectors allowing the image forming module to be automatically and electrically connected or disconnected to or from a power supply section and a controlling section of the main body when the image forming module is mounted or dismounted.

9. The apparatus as claimed in claim 1, wherein the transfer unit comprises a transfer belt and a plurality of first transfer rollers which are mounted inside the transfer belt to correspond to the photosensitive members.

10. A color image forming apparatus comprising:
an image forming module including a plurality of elements comprising a photosensitive member, a plurality of electrification units, a plurality of exposure units, developing units, and an image forming frame which detachably receive and support the plurality of elements; and
a main body to which the image forming module is removably mounted and including a medium delivery unit to deliver a printing medium so that the image is transferred from the photosensitive member.

11. The apparatus as claimed in claim 10, wherein the image forming frame is integrally formed.

12. The apparatus as claimed in claim 10, further comprising:
a plurality of mounting recesses formed in the image forming frame to receive the photosensitive member, the image forming units, the developing units, and the exposure units, respectively; and
a plurality of positioning members which determine a correct position when the image forming units, the developing units, and the exposure units are mounted to the corresponding mounting recesses.

13. The apparatus as claimed in claim 12, wherein the positioning members comprise a reference pin and a reference hole corresponding thereto, each formed to any one of the image forming frame and the developing unit and to any one of the image forming frame and the exposure unit.

14. The apparatus as claimed in claim 10, wherein the image forming frame is provided with a connector allowing the image forming module to be automatically and electrically connected or disconnected to or from a power supply section and a controlling section of the main body when the image forming module is mounted or dismounted.

15. The apparatus as claimed in claim 10, wherein the photosensitive member is substantially belt shaped.

16. A color image forming apparatus comprising:
an image forming module including a plurality of elements comprising a plurality of image forming units having photosensitive members, a plurality of exposure units to expose the photosensitive members, a transfer unit for transferring an image formed on the photosensitive member to a printing medium and an image forming frame which detachably receives and supports the plurality of elements; and
a main body to which the image forming module is removably mounted and including a medium delivery unit for delivering the printing medium to the transfer unit.

17. The apparatus as claimed in claim 16, wherein the image forming frame is integrally formed.

18. The apparatus as claimed in claim 16, further comprising:
a plurality of mounting recesses formed in the image forming frame to receive the image forming units and the exposure units, respectively; and
a plurality of positioning members which determine a correct position when the image forming units and the exposure units are mounted to the corresponding mounting recesses.

19. The apparatus as claimed in claim 18, wherein the positioning members which determine a correct position comprise a reference pin and a reference hole corresponding thereto, each formed to any one of the image forming frame and the image forming unit and to any one of the image forming frame and the exposure unit.

20. The apparatus as claimed in claim 19, wherein the positioning members of the exposure unit further comprise an exposure unit-supporting section and a corresponding surface provided to the image forming frame and the exposure unit, respectively.

21. The apparatus as claimed in claim 16, further comprising a frame-positioning assembly which determines a correct position of the image forming module in the main body when the image forming module is mounted to the main body.

22. The apparatus as claimed in claim 21, wherein the frame-positioning assembly comprises a plurality of reference protrusions formed on the frame of the image forming module and reference grooves formed on the main body and corresponding to the reference protrusions.

23. The apparatus as claimed in claim 16, wherein the image forming frame is provided with a connector allowing the image forming module to be automatically and electrically connected or disconnected to or from a power supply section and a controlling section of the main body when the image forming module is mounted or dismounted.

24. The apparatus as claimed in claim 16, wherein the transfer unit comprises a delivery belt and a plurality of transfer rollers which are mounted inside the delivery belt to correspond to the photosensitive members.
